(19) United States
(12) Patent Application Publication
(10) Pub. No.: US 2014/0279527 A1
(43) Pub. Date: Sep. 18, 2014

(54) Enterprise Cascade Models

(71) Applicant: SAS Institute Inc., Cary, NC (US)

(72) Inventors: Brian Lee Duke, Poway, CA (US); Paul C. Dulany, San Diego, CA (US); Vijay Desai, San Diego, CA (US); Kannan Shashank Shah, San Diego, CA (US)

(73) Assignee: SAS Institute Inc., Cary, NC (US)

(21) Appl. No.: 14/062,062

(22) Filed: Oct. 24, 2013

Related U.S. Application Data
(60) Provisional application No. 61/782,537, filed on Mar. 14, 2013.

(51) Int. Cl. G06Q 20/40

(52) U.S. Cl. CPC G06Q 20/40
USPC 705/44

(57) ABSTRACT

Methods, systems, computer-readable media, and apparatuses for detecting unauthorized activity are disclosed. Detecting unauthorized activity is done by accessing first data that represents activity involving a first service provided to a customer, accessing second data that represents activity involving a second service provided to a customer. The activity involving the second service and the activity involving the first service both include authorized customer activity, and the activity associated with the second service further includes unauthorized activity. The first data is filtered using a filtering criteria and a portion of the first data is selected to be retained. The second data and the retained portion of the first data are analyzed, and the analysis includes classifying the activity associated with the second service in a way that distinguishes the unauthorized activity from the authorized activity associated with the second service.

The present application is a non-provisional of and claims the benefit and priority under 35 U.S.C. §119(e) of U.S. Provisional Application No. 61/782,537, filed on Mar. 14, 2013, and entitled “Enterprise Cascade Models,” and which is incorporated by reference herein for all purposes.

### BACKGROUND

Aspects of the disclosure relate to the efficient detection and classification of unauthorized transactional activity through the analysis of transactional data.

Banks, financial institutions and other entities frequently employ algorithms to detect unauthorized, risky, or suspicious activity affecting customer accounts. Commonly, these algorithms monitor customer accounts individually by analyzing data observations which are gathered when activity involving the account occurs. A corpus of historical data observations can be referenced to determine typical user behavior, including account usage trends and patterns. When typical user activity is documented, recent or real-time observations can be analyzed in search of information depicting abnormal, inconsistent or rapidly changing account activity. When such information is detected, appropriate security measures may be implemented to protect the account, as dictated by the level of risk ascertained from the information.

### BRIEF SUMMARY

Certain embodiments of the techniques, processes and other subject matter disclosed herein include methods for detecting unauthorized activity by accessing first data that represents activity involving a first service provided to a customer, accessing second data that represents activity involving a second service provided to a customer, wherein the activity involving the second service and the activity involving the first service both include legitimate customer activity, and wherein the activity associated with the second service further includes unauthorized activity, accessing filtering criteria for filtering the first data, wherein the filtering criteria facilitates selecting a portion of the first data for use in classifying activity associated with the second service, filtering, on a computing device, the first data, wherein filtering is performed using the filtering criteria and includes selecting a retained portion of the first data, the retained portion of the first data being separate from another portion of the first data that is not retained, and analyzing the second data and the retained portion of the first data, wherein analyzing includes identifying the unauthorized activity.

Other embodiments of the techniques, processes and other subject matter disclosed herein include systems for detecting unauthorized activity, and which include a processor configured to performs operations, the operations including accessing first data that represents activity involving a first service provided to a customer, accessing second data that represents activity involving a second service provided to a customer, wherein the activity involving the second service and the activity involving the first service both include legitimate customer activity, and wherein the activity associated with the second service further includes unauthorized activity, accessing filtering criteria for filtering the first data, wherein the filtering criteria facilitates selecting a portion of the first data for use in classifying activity associated with the second service, filtering, on a computing device, the first data, wherein filtering is performed using the filtering criteria and includes selecting a retained portion of the first data, the retained portion of the first data being separate from another portion of the first data that is not retained, and analyzing the second data and the retained portion of the first data, wherein analyzing includes identifying the unauthorized activity.

Other embodiments of the techniques, processes and other subject matter disclosed herein include computer-program products for detecting unauthorized activity, the computer-program products including a non-transitory computer-readable with instructions stored thereon, the instructions being operable to cause a computer, processor, computational device or combination thereof to perform operations, the operations including accessing first data that represents activity involving a first service provided to a customer, accessing second data that represents activity involving a second service provided to a customer, wherein the activity involving the second service and the activity involving the first service both include legitimate customer activity, and wherein the activity associated with the second service further includes unauthorized activity, accessing filtering criteria for filtering the first data, wherein the filtering criteria facilitates selecting a portion of the first data for use in classifying activity associated with the second service, filtering, on a computing device, the first data, wherein filtering is performed using the filtering criteria and includes selecting a retained portion of the first data, the retained portion of the first data being separate from another portion of the first data that is not retained, and analyzing the second data and the retained portion of the first data, wherein analyzing includes identifying the unauthorized activity.

### BRIEF DESCRIPTION OF THE DRAWINGS

Aspects of the disclosure are illustrated by way of example. In the accompanying figures, like reference numbers indicate similar elements, and:

FIGS. 1A and 1B are simplified diagrams of an example of a system used to detect fraudulent or unauthorized credit card transaction requests and bank transaction requests, respectively;

FIG. 2 depicts a block diagram of an example of a system embodying certain aspects of the present disclosure.

FIG. 3 illustrates generalized example operations of data filtering and activity classification in accordance with certain techniques of the present disclosure.

FIG. 4 depicts example procedures for classifying requested credit card activity data in accordance with certain of the techniques disclosed herein.

FIG. 5 is a flow chart depicting example sequences of operations and procedures executed in accordance with certain methods and techniques of the present disclosure.

FIG. 6 is a flow chart depicting example sequences of operations and procedures executed in accordance with certain methods and techniques of the present disclosure.

FIG. 7 is a flow chart depicting example sequences of operations and procedures executed in accordance with certain methods and techniques of the present disclosure.

FIG. 8 is an example filtering rule evaluation table generated in accordance with certain techniques of the present disclosure.

FIG. 9 is a chart describing example combinations of operations and procedures executed in accordance with certain methods and techniques of the present disclosure.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims. Where this disclosure provides specific details, examples, implementations or algorithms related to the subject matter at hand, each such specific description shall be understood as being provided for explanatory purposes only, and as such, indicates only one of the many embodiments which will be readily recognizable to people of ordinary skill in an art to which this disclosure is directed. Thus, no such specific description shall be construed as expressly or impliedly limiting, defining, or delineating the scope of the inventive subject matter presented herein.

Banks, financial institutions, e-commerce businesses, and other entities can use analytical algorithms to monitor data generated by customer account activity. The data details activity involving the account, and tends to be analyzed promptly after being registered. For example, when a credit card customer swipes a credit card to make a transaction, data observations are recorded. These observations often include an identification of the credit card account being used, the amount of currency involved in the requested transaction, a location or business identification of the merchant accepting the credit card, and a timestamp, among other things.

Processing the requested credit card transaction may involve transmission of the data to a remote server, via a secure payment system network connection. At the remote server, the data is analyzed by a classification and scoring algorithm for detecting unauthorized credit card activity. Typically, the algorithm can use stored data resulting from the customer's previous account activity or interpretive parameters, guidelines, or formulas previously calculated in response to information learned about the customer through past account activity

If the algorithm determines that the requested transaction is likely to have been legitimately requested by the customer, the requested transaction is classified as authorized and further processed to completion. Otherwise, the transaction may be classified as unauthorized and declined. In both cases, the data observations recorded in response to the requested transaction are stored, and may also be used to update any interpretive parameters, guidelines, or formulas used by the fraud detection algorithm to analyze the customer's account activity.

By detecting unauthorized account activity, a bank may be able to avoid costs associated with fraud. However, unauthorized transactions tend to be far less frequent than legitimate transactions and can be very hard to detect. Sophisticated fraudsters frequently moderate, diversify and alter their activity to avoid generating abnormal or outlying transactional data and hinder detection mechanisms. Moreover, when fraudulent activity is not detected by a detection algorithm and results in an approved transaction, the approved transaction may eventually improperly affect the collection of data which the algorithm uses to interpret the customer's normal behavior (e.g. eventually, the fraudulent/abnormal behavior will come to look normal after some time has passed).

Also, there can be costs associated with incorrectly classifying legitimate account activity as being unauthorized. For example, by rejecting a legitimately requested transaction or blocking a credit card account in response to an erroneous transaction classification, a credit card company may cause customer dissatisfaction, incur administrative costs, and lose the opportunity to loan money or generate service fees. In fact, over a sample of numerous approved credit card transactions, the costs associated with such erroneous responses to legitimate activity (i.e., “false-positive” detections) may be substantial in comparison with costs resulting from failures to detect unauthorized transactions.

Within the financial services industry, internet commerce, and other transactional arenas within the scope of this disclosure, algorithmic detection and classification of unauthorized activity is characterized by a frequently encountered theme. In many classification environments, a majority (and very high volume) of activity can be very accurately classified with relative ease. For most transactions in this group, these accurate results can be obtained by analyzing only a relatively small amount of data, and subjecting that limited data to a small number of analytical processes (i.e., performing few computations). Additionally, most of this activity may entail relatively minimal risk for the hosting entity with which the activity is conducted (e.g., a credit card company, bank, or other participating entity on behalf of which classification is performed).

However, much of the remaining small percentage of activity may be exceedingly difficult to analyze, while at the same time entailing large financial risks (false-positive or false-negative risks) or rewards (the payback on a true-negative or true-positive classification) for the classifying entity. In classifying this portion of activity, very complex algorithms capable of analyzing vast amounts of data in many different ways may be necessary to obtain reliable classification results. Moreover, although there is room for substantial improvement in classifying this portion of activity, achieving meaningful improvements in classification performance may often necessitate increases in data-analysis capacity and algorithmic complexity. Nonetheless, in light of the fact that most activity can be accurately detected with simple algorithms, there is a risk of deleteriously wasting processing resources and thereby diminishing classification capabilities by misapplying a high-order detection algorithm to classify activity which does not necessitate higher-order analysis to be accurately classified.

The present disclosure presents techniques which may be used both to increase the rate at which unauthorized account activity is detected and decrease the rate at which a fraud detection algorithm makes false-positive detections. Moreover, the techniques may be implemented in an efficient manner, such that only moderate increases in data storage and data processing are required, as compared to the techniques for detecting unauthorized account activity which are in current use.

As previously mentioned, unauthorized account activity is currently detected by analyzing transactions in light of past historical data associated with a customer's account activity and background customer information obtained during creation or maintenance of the account. However, entities that provide a particular type of service to customers also provide many of those same customers with separate services. In such cases, the entity separately obtains activity data related to the provided services.

For example, a bank may provide a credit card service to an individual customer. As a result of providing the credit card service, the bank will ordinarily obtain personal data, transaction history data, credit information, data related to account maintenance, and other information depicting or related to the use of the customer's credit card and maintenance of the credit card account. In many cases, the same bank may also provide one or more additional services to the same customer, or to a group with which the customer is affiliated.

Thus, the customer may have a checking or savings account, investment portfolio, trust, security deposit account, or other customer service account held at the same bank that provides the credit card service. The bank could also have a creditor-debtor relationship with the customer involving a home loan, auto loan, small business loan, or any other type of service. In any of these example bank-customer relationships, the bank may separately accumulate activity data involving any of the additional provided services, in addition to the information associated with the customer's credit card account. The activity data involving the additional provided services may provide valuable information relevant to the analysis and classification of credit card activity.

However, current unauthorized activity detection mechanisms perform only isolated analysis of data associated with a provided service, even when the service is used by a customer who also uses an additional service provided by the same financial institution. Thus, in the case of a customer who is both a credit card and banking customer of a financial institution, credit card activity data is not taken into account when debit card activity data is analyzed to detect unauthorized, fraudulent, or risky activity involving only the customer's debit card account. Similarly, credit card activity data is separately analyzed in isolation, and only for the purpose of detecting unauthorized, fraudulent, or risky activity involving the credit card account.

FIG. 1A illustrates a simplified diagram of a widely-used system 100A for processing credit card transactions and detecting unauthorized activity involving a customer's credit card account. As depicted in FIG. 1A, system 100A includes a remote server 104A which includes a credit historical data library 105A, a credit card authorization and transaction processing module 106A and a customer account security module 108A. System 100A also includes various merchant-customer transaction interfaces 102A. Merchant-customer transaction interfaces enable customer credit card information to be inputted when the merchant wishes to complete a transaction. Common web-based payment portals and credit card terminals are two examples of a merchant-customer transaction interface 102A.

As depicted in FIG. 1A, a user (the customer, in the case of an authorized transaction—or a fraudster or other user, in the case of an unauthorized transaction) inputs credit card data through a merchant-customer transaction interface 102A in order to complete a transaction. Transaction interface 102A transmits the inputted data, as well as other data depicting the requested transaction, as part of an authorization request. The authorization request is transmitted to the remote server 104A. Commonly, the authorization request will include data components which describe the amount of currency proposed to be transacted, an authorization request time stamp, and an identification and location of the merchant involved in the requested transaction.

The data is processed at the remote server 104A, which uses the authorization module 106A to determine whether the transaction should be authorized. Authorization module 106A accesses the credit card historical data library 105A to obtain stored credit card activity data, parameters, or interpretive guidelines related to the customer's credit card account. The activity data, parameters, or interpretive guidelines are routinely updated based on the customer's use and maintenance of the credit card account. For example, updates may be performed whenever the customer makes a purchase using the credit card, changes an address associated with the account, or makes an online banking login.

Authorization module 106 analyzes and classifies the proposed transaction using the obtained data, parameters, or interpretive guidelines. Classification of the proposed transaction includes classifying the transaction as an authorized transaction or unauthorized transaction, and is done based on an estimation of the likelihood that the transaction is risky or fraudulent. Classification may also include assigning a score to the transaction based on the estimated likelihood.

If the proposed transaction is classified as an authorized transaction, the transaction is approved and an indication of approval is transmitted to the merchant-customer transaction interface. Following approval, the authorization module uses the activity data depicting the proposed transaction to update the credit card authorization and transaction processing module 106A so that the customer's history of credit card activity reflects the newly obtained information about the customer's activity.

If the proposed transaction is characterized as an unauthorized transaction, a rejection message is transmitted to the merchant-customer transaction interface. Also, the fraud score assigned to the transaction is reviewed by the customer account security module 108. Based on the fraud score, the customer account activity security module 108 activates additional security measures. For example, in response to a very high fraud score (e.g., highly suspicious and/or very risky credit card activity), the customer activity module 108 may completely deactivate the customer's credit card, send a phone or text message warning to the customer, and/or deactivate the customer's online password. Alternatively, when a proposed transaction is classified as unauthorized but the fraud score is much lower, the customer activity module 108 may impose less stringent security measures. For example, the customer activity module 108 may command a phone call or text message be sent to the customer to determine if the transaction was actually legitimate. In certain cases, the customer activity module may impose these measures for certain transactions which result in both an authorized classification and a fraud score which is higher than average for approved transactions.

FIG. 1B also shows a commonly-used system 100B which enables the same customer to also obtain debit card services. The debit card services may be provided to the customer by the same company or institution which provides the credit card services described with reference to system 100A. Alternatively, the debit card services may be provided by a company or institution which conducts business in association with the company or institution which provides the customer with credit card services through system 100A. Components of this system are denoted using a number and letter labeling. Moreover, each component of system 100B performs a function similar to the commonly-numbered component of system 100A. However, each component of system 100B handles data and processing of debit card transactions only.

As illustrated by credit card system 100A, debit card system 100B, and the depicted independence of these systems, debit card transactions involving a customer account are processed and approved or rejected without regard to data or activity involving the customer's credit card account. Similarly, credit card transactions involving the customer's credit card account are processed and approved or rejected without regard to data or activity involving the customer's debit card account.

Similar combinations of systems for performing isolated, parallelized processing, transaction scoring and classification are encountered when other combinations of services are provided to customers by a single entity. For example, ATM (whether related to a checking, money market, savings account, etc.) fraud detection mechanisms are currently used by many financial institutions to evaluate customers' history of ATM activity so as to be able to classify and make authorization decisions regarding requested ATM transactions. Within any one of these institutions, several of the banking customers may also own an investment account. In this case, proposed investment account transactions generate activity data which is analyzed and evaluated by an investment account fraud detection mechanism in light of stored historical data, parameters or interpretive guidelines derived from the customer's history of using and managing the investment account.

The present application proposes techniques for improving a detection mechanism's performance characteristics in monitoring the accounts of customers who obtain multiple services from a related entity, or for whom a history of activity involving multiple services is otherwise available. The techniques involve selectively broadening the analysis of customers' activity data history so that, in certain circumstances, individual classifications and authorization decisions with respect to requested customer activity are based on activity data associated with a customer's use of multiple (two or more) services.

This application provides example techniques for performing such analysis when multiple sources of data are used in combination to inform individual fraud detection decisions and security responses. Also, in order to prevent the broadening of data sources from requiring an excessive amount of processing or data storage resources, techniques are provided for filtering the data in a cost-effective way, so as to obtain significant improvements in classification performance in a manner which is efficient and practical in light of the processing resources available.

The techniques of the present disclosure shall be understood as applicable within any context involving an attempt to detect unauthorized, illegal, risky or fraudulent activity (hereinafter, unauthorized, illegal, risky, or fraudulent activity will be referred to simply as “fraud,” even though such activity need not involve fraud or deception) involving any type of service (“first service” for ease of reference) provided to a customer by an entity, provided that the entity also has access to data related to an additional service (“second service,” and possibly, but not necessarily, a “third service,” “fourth service,” etc.), and that this additional data depicts some customer activities separate from the customer's use of the first service. Moreover, the term “customer” shall be understood herein to refer to any person, group, business, institution, or association which acts as a customer. The term customer may also refer simultaneously to an individual, family or group which has access to a first service, and a broader or different group which has access to a second service and is in some way associated with the individual, family or group connected with the first service. Thus, for example, this disclosure shall be understood as being applicable in the case of a financial institution which provides a financial service to an individual, and which also provides, through a separate account, a same or different service to a charity, trust, small business, or other organization controlled or influenced in some way by the individual.

FIG. 2 illustrates a generalized system for detecting unauthorized activity involving any one of three services provided to a single customer. The system of FIG. 2 may additionally be used to detect unauthorized activity involving a service provided to one or more other customers who obtain only one service from the entity. However, when this additional type of detection is performed, certain components of FIG. 2 may be excluded from the detection process. The entity providing the service or services to the customers may be a bank, brokerage service, savings institution, insurance company, or any other type of entity capable of providing multiple types of customer service which could be used in an unauthorized, risky, fraudulent, or illegal manner.

FIG. 2 shall be understood to illustrate one example implementation of the techniques disclosed herein. Several other alternative implementations of the techniques will be recognizable to a person of ordinary skill in the art having reference to the present disclosure. Moreover, the following discussion of the implementation depicted in FIG. 2 is provided only for exemplary purposes, and shall not be understood to limit the scope of this disclosure in any way.

The detection system 200 may be used to detect unauthorized activity related to usage of a first, second or third service or account provided to any number of customers. However, as will be explained in greater detail later on, when system 200 is used to analyze and classify requested activity, certain components of the system may perform analysis using data which is unique to the customer whose identifying information, credentials, or account information is invoked by the activity request. Thus, for explanatory reasons, and in the interest of simplicity, the operations of system 200 and its components will be described only with regards to requested activity which invokes the identifying information, credentials, or account information of a single example customer (in the following discussion of FIG. 2, this customer will be referred to as “the customer”) to which the first, second and third service is provided. This focus of the discussion shall in no way limit the scope of this disclosure from including detection systems which may be applied to more than one customer account independently.

As depicted, system 200 enables customers to use both a first, second and third service. This combination of services may include any services which involve using a customer identity, password, transaction card, or other account or customer information, and are therefore at risk of fraudulent or unauthorized use. Alternatively, any one of the services could be a service which, for any reason, may require monitoring or control to prevent abuse of the service, illegal activity, or excessive risk-taking.

When system 200 is used by a customer for requesting activity involving the first, second or third service, the customer submits the request through either interface and portal 260, 262 or 264, depending on which service is being requested. Portals 260, 262 and 264 are configured to generate activity request data. Commonly activity request data will include an IP or network number to identify the portal at which the request is inputted. The interface and portals 260, 262, 264 are also configured to generate additional activity request data which is appropriate for the respective services which they facilitate. As one example of an interface and portal which may be implemented within system 200, if the first service is a credit card account, interface and portal 260 could be a conventional credit card reader similar to those commonly found at supermarkets, retail stores, and restaurants. If the first service is a bank account, interface and portal 260 could be a conventional ATM machine or debit card reader.

Hereinafter, both a request for activity and any data generated in response to the request may be referred to interchangeably as “activity request data,” “activity data,” “activity history data,” “activity,” an “activity request,” “requested activity,” or may be referred to using any other such similar term. Moreover, these interchangeable terms shall not imply any difference from one to the other. The term “activity request data” may be used at times for purposes of clarity or differentiation. For example, when multiple sources of data are discussed as being used for the purpose of classifying an instance of requested activity, use of the term “activity request data” may provide a means of differentiating the data generated in response to the request from other sources of data.

Within system 200, three detection modules, 202, 204, 206 are provided to process activity requests made at portals 260, 262 and 264, respectively. The detection modules 202, 204, and 206 may be located within a single server (not shown), or may reside at separate servers. Detection module 202 is configured to detect unauthorized activity requests by preliminarily analyzing, scoring and classifying requests for activity which would involve the first service. Similarly, detection modules 204 and 206 are configured to detect unauthorized activity by preliminarily analyzing, scoring and classifying requests for activity which would involve the second and third service, respectively (hereinafter, the first, second and third service will be described as either the “service corresponding to” detection module 202, 204 and 206, respectively, or as the “corresponding service” or “respective service” when reference is made to detection module 202, 204, or 206, respectively). Hereinafter, when reference is made to any particular request for activity, the detection module 202, 204, or 206 which performs the respective preliminary analysis, scoring and classification will be referred to as the “classifying detection module”.

As will be explained in greater detail in subsequent paragraphs, in classifying and scoring requested activity involving their respective services, the detection modules 202, 204, and 206 primarily evaluate customer information and history data related to the customer's use of the service being analyzed. Additional processing is also performed by other components of system 200 whenever a request for activity involving the first, second, or third service is received. The outcome of this additional processing determines whether the initial detection module classification is maintained without further evaluation, or whether the activity request data is reevaluated in light of supplemental data—i.e., data depicting a customer's history of activity involving services not corresponding to the classifying detection module 202, 204 or 206.

As one example of the combinations of services to which system 200 may be applied, the first service may be an active credit card account, the second service may be a bank account, and the third service may be a securities brokerage account. Classifying a request for activity may involve determining a likelihood that the requested activity is not authorized by the customer, or is fraudulent, illegal, or excessively risky (hereinafter the term “unauthorized” will refer to any activity or requested activity which is unauthorized, fraudulent, illegal, or excessively risky) for the entity providing the first, second, and third services (hereinafter, this entity will be referred to simply as “the entity”). Classifying requested activity may involve classifying the activity as authorized activity or unauthorized activity. Scoring requested activity may involve providing a score which supplements the classification. The score provides a detailed quantification of a calculated likelihood that the classified request proposes activity which is unauthorized.

Each score provided by a detection module 202, 204, or 206 may be stored along with the activity request data for which the score was given. These scores may later be evaluated, in conjunction with human and expert data, so as to evaluate, understand, and refine or retrain the algorithms executed by the detection modules. For example, human experts may be used to investigate requested activity classified as unauthorized and, based on a thorough investigation, may generate highly-accurate conclusions in this regard. Additionally, when unauthorized activity is improperly classified as authorized, merchants and customers may provide inputs which can be used to generate highly-reliable fraud labels. By analyzing a historical record of activity data, detection module classifications, fraud scores, and accurate post-investigation fraud labels, the performance characteristics (e.g., variability/consistency, overall accuracy, and strength/weakness characteristics) of the algorithms executed by a detection module may be understood.

When any one of the detection modules 202, 204, or 206 analyzes a request for activity and classifies it as unauthorized, that detection module provides a communication that results in the request being declined or rejected. Declining or rejecting a request may involve cancelling a requested transaction, preventing access to an account, providing an error message, declining an ATM withdrawal, or any other rejection action appropriate under the circumstances specific to the requested activity being rejected. System 200 may also be configured to impose additional preliminary security measures in response to the unauthorized classification. The preliminary security measures may be one-time measures, temporary measures, or measures which remain in effect pending action by the customer.

System 200 may determine the additional preliminary security measures based on the score generated along with the “unauthorized” classification. An appropriate security measure may be determined based on the vulnerability or risk indicated by the score. The system may select one or more security measures from amongst multiple available security measures providing different levels of protection. Thus, if a detection module 202, 204, or 206 detects a high degree of vulnerability and therefore assigns a high score to a rejected activity request, system 200 may fully prevent the customer from using the service invoked by the rejected request. If the score indicates a much lower degree of vulnerability, the system 200 can impose a less secure security measure such as locking the customer's account for a brief period of time or initiating a phone or text message warning or authorization inquiry directed to the customer. In certain cases, system 200 may determine not to impose any measure beyond a simple rejection of the requested activity.

With regards to detection modules 202, 204, and 206, these modules may be configured to analyze, classify, and score a wide variety of requested activities. The requested activity may include any requested activity which is generally made available as part of the service corresponding to the particular detection module 202, 204, or 206. For instance, in an exemplary case in which the first service is a credit card account, detection module 202 could be configured to individually classify and score requested transactions involving the customer's credit card account information, whether placed through a merchant, website, ATM, telephone, text, message-based service, or other transaction portal. Also, in this case, detection module 202 could be configured to analyze, classify, and score online credit card account logins, password changes, access attempts, account inquiries, changes of personal information, change of service requests, and any other type of credit account activity which could be unauthorized or used for illegal, fraudulent, harmful, or risky purposes.

The detection modules 202, 204, and 206 classify requested activity based on historical data describing past customer use of their respective services. As part of this process, the detection modules 202, 204, and 206 may perform analysis using interpretive guidelines, parameters, rules, procedures, or formulas based on the customer's history of activity involving their respective services. The detection modules 202, 204, and 206 may update and augment this information to reflect most recent activity request data, analysis, and classifications. Any such historical data or information which is generated, obtained, stored, or processed by a detection module 202, 204, or 206 for the purpose of analyzing later requested activity will be referred to as customer interpretive information.

Data storage structures 208, 210, and 212 are used to store customer information with regards to their respective services. Hereinafter, as indicated in FIG. 2 for ease of reference, this disclosure will refer to the sets of interpretive information stored in data storage structures 208, 210, and 212 as set A, set B, and set C, respectively. As depicted, detection modules 202, 204, and 206 have direct access to set A, set B, and set C, respectively.

Data storage structures 208, 210, and 212 are used by, and correspond to, detection modules 202, 204, and 206, respectively. As such, data storage structures 208, 210, and 212 also correspond the first service, second service, and third service, respectively. Data storage structures 208, 210, and 212 may be located within the same server as the detection module 202, 204, and 206 to which each structure corresponds, or may reside separately.

Any or all of the detection modules 202, 204, and 206 may incorporate a neural network, machine-learning, or artificial intelligence algorithm trained with historical data. Such an algorithm may be used to analyze customer interpretive data and provide classification and scoring of requested activity. The training of such an algorithm for analyzing requested activity involving a particular customer's account may involve using historical training data depicting some of that customer's previous account usage activity. Additionally or alternatively, the training data may include historical activity data depicting the activity of other previous customers who used the same service as the customer, and had personal characteristics (e.g., income, address, profession, marital status, joint user permissions, or any other relevant characteristic) or consumer tendencies similar to the customer. The training data may include transactional information describing each of numerous historical transactions or other customer activities deemed to be legitimate. For purposes of this disclosure, a transaction or activity is legitimate when it is authorized by the customer, does not violate a term or condition of service applicable to the customer, and is neither fraudulent nor illegal. The training data may also include transaction data connected with historical transactions or other customer account activities known to have been unauthorized.

Because the detection modules 202, 204, and 206 only analyze customer interpretive data related to their respective services, the observations, information, and data reviewed by a classifying detection module 202, 204, or 206 is limited to a smaller subset of the total data and observations than are processed by system 200 as a whole. This use of segmented analysis and processing enables the avoidance of unnecessary computational complexity within detection modules 202, 204, and 206. By avoiding complexity, each detection module 202, 204, and 206 is able to perform the processing needed to classify and score requested activity in a manner that is fast enough for customers to obtain suitable service. Because the classification performed by detection modules 202, 204, and 206 is segmented, may require relatively few resources, and can be performed in minimal time, classification by detection modules 202, 204, and 206 will, at times, be referred to hereinafter as “simple-efficient classification.”

However, although simple-efficient classification can be done in minimal time, exclusive reliance on simple-efficient classification may not be optimal in all cases. For example, in certain instances of requested activity related to use of a particular service, classification and scoring may be improved further by combined analysis of information related to the customer's use of other services.

For example, this type of opportunity for improvement could occur in a situation in which a customer obtains and uses credit card, personal banking, and brokerage services provided by a single business entity. An activity request could invoke this customer's credit card account information as part of a requested transaction occurring at a location that is both far from the customer's home and substantially removed from all other locations indicated by the customer's historical credit card activity. However, in such a case, the requested transaction might occur near where the customer made previous authorized checking account withdrawals. The location might also be near where the customer made legitimate branch visits to manage a brokerage account. In this hypothetical situation, if only the customer's history of credit card activity is considered (e.g., as part of simple-efficient classification), the requested credit card transaction could appear sufficiently abnormal to be rejected by a detection module such as detection module 202, 204, or 206.

However, this customer's checking account withdrawal and branch visit history provide supplemental information that implies that the requested credit card transaction is less likely to be unauthorized than simple-efficient classification alone would find. In other words, a more informed understanding of the requested credit card transaction could be used to better classify it. In fact, a large amount of supplemental information, such as the information described in this example scenario, may be used to improve classification of a wide variety of requested activity, as compared to the performance of single-stage, simple-efficient detection module classification.

Nonetheless, although classification accuracy can generally be improved through the analysis of data related to multiple services, the evaluation of multiple sources of data as part of each requested activity classification may not always be efficient and practical. For many instances of requested activity, the simple-efficient analysis performed by detection modules 202, 204, or 206 may provide highly reliable classification. For example, a majority of credit card customers make frequent, routine transactions near their workplace or residence in a very predictable manner. Moreover, in many of these cases, the transaction dollar amount is small, meaning that the transaction carries little risk for the entity providing the requested credit card service. A detection module such as detection module 202 may be able to classify these transactions with a very high degree of accuracy, while using only simple-efficient classification techniques. Moreover, the fact that the transaction dollar amounts are small means that the few errors made in classifying them with simple-efficient analysis may result in minimal financial harm to the operating entity.

In classifying these and other similar transactions, it may be inefficient or impractical to evaluate banking, brokerage, insurance or other service data related to the customer. Moreover, in the case of these routine transactions, the consideration of such additional information may provide insignificant or no improvement in classification results, as simple-efficient classification by itself may suffice for extremely accurate classification with minimal room for improvement.

In accordance with the present disclosure, a cascaded enterprise classification module 220 may be efficiently used to review a portion of the simple-efficient classifications made by detection modules 202, 204, and/or 206. When reviewing a classification of requested activity involving a service provided to the customer, the cascaded enterprise classification module 220 is provided with some supplemental customer activity data so as to increase its evaluation accuracy. Supplemental customer activity data may be understood as referring to data that depicts a customer's history of activity involving one or more additional services (accounts) apart from the customer's use of the account invoked by the reevaluated activity request. For example, when further evaluating any requested activity classification made by detection module 202, the enterprise classification module 220 may consider the data in set A, in combination with any amount of supplemental data in set B and any amount of supplemental data in set C.

The enterprise detection module 220 may reevaluate an activity request involving one service by processing the corresponding activity request data, in conjunction with supplemental data related to another service, in order to classify the requested activity. This processing may occur while the request is still pending and the activity—whether a transaction, login, address change, or any other form of activity—has not yet been finalized/approved/etc. In this case the data depicting the reevaluated request is truly requested activity data, and any classification provided by enterprise detection module 220 may determine whether the requested activity may be processed or allowed to take place. Additionally or alternatively, the enterprise detection module 220 may classify activity generated in response to a request for activity at some time after the requested activity has been rejected or allowed to occur. In such a situation, it may be more accurate to say that enterprise detection module 220 classifies activity or activity data (as opposed to requested activity or activity request data), as a request no longer remains pending. Despite this distinction, this disclosure may interchangeably refer to the enterprise detection module 220 classification process reevaluating “activity request data,” “activity data,” “requested activity,” or “activity requests,” without implying anything about the pendency of a request or whether the activity already took place.

The enterprise detection module 220 may be implemented using a neural network which employs adaptive-learning techniques. The enterprise detection module 220 may alternatively or additionally use any other decision-making algorithm or combination of algorithms, to include artificial intelligence or machine-learning algorithmic techniques. Furthermore, implementation of the enterprise detection module 220 may involve semi-supervised or supervised learning features or techniques, or a combination thereof.

The enterprise detection module 220 may be configured to classify requested activity by analyzing a collection of data which, in the aggregate, depicts customer activity involving more than one service. Moreover, the detection module 220 may be configured to flexibly analyze various combinations of data. The various combinations of data may include different quantities of data observations, and different types of data. Additionally, the enterprise detection module 220 may dynamically select analytic methods or combinations of methods depending on the breadth of data, the services or activities which the data relates to, or the informational content provided by the data.

For example, the enterprise module 220 may be configured to classify a single instance of requested credit card activity by collectively analyzing data depicting the requested activity and data depicting numerous or only a few checking account transactions completed by the customer. The credit card requested activity data could include data components not found within the checking account data, and vice versa. For instance, credit card requested activity data could include information identifying a merchant connected to the requested activity, while the checking account data could include information depicting an ATM location connected with account activity, or information depicting whether activity was conducted via telephone or in person.

As one example of enterprise module classification flexibility, the same enterprise module 220 may also be configured to collectively analyze data depicting an instance of requested credit card activity by analyzing data depicting that request, in combination with a large corpus of data depicting many instances of past credit card transactions completed by the customer, a few instances of checking account transactions, and any number of brokerage account transactions.

Pre-enterprise filter 222 filters activity request data and resulting detection module 202, 204, or 206 activity request classifications to determine which activity request data will be reevaluated by the enterprise module 220. Hereinafter, when pre-enterprise filter 222 determines that data should be evaluated (or reevaluated) by the enterprise detection module 220, this data will be referred to as being “retained” by the pre-enterprise filter 222. By retaining only certain activity request data for reevaluation, the pre-enterprise filter 222 prevents the reevaluation of classifications which are very likely to have been performed correctly by detection modules 202, 204, or 206. Furthermore, pre-enterprise filter 222 may additionally function to prevent the enterprise detection module 220 from reevaluating otherwise routine requested activity which carries minimal risk for the entity.

The pre-enterprise filter 222 may also function to prevent reevaluation of some other classifications for which a reevaluation would be unlikely to result in a changed classification. This filtering situation may arise, for example, at certain times when a detection module 202, 204, or 206 outputs a fraud score within a score range normally associated with poor detection module performance. In certain such circumstances, despite the high probability of an erroneous detection module classification, it is possible for the activity request data and/or supplemental data to be uninformative, sparse, or affected by some other factor or characteristic known to cause similarly poor enterprise module 220 classification performance.

Also, when pre-enterprise filter 222 retains requested activity data so that the enterprise module 220 may reevaluate it, the pre-enterprise filter 222 also serves to filter supplemental data so as to prevent the enterprise module 220 from receiving data which is unlikely to be relevant or informative for performing the reevaluation at hand. In this way, enterprise module 220 analyzes activity request data in combination with supplemental data. However, despite the higher-dimensional data space used by the enterprise module 220, excessive processing and computational complexity are avoided because pre-enterprise filter 222 effectively limits enterprise module 220 operations to the classification of activity request data most susceptible to simple-efficient classification error, and ensures that the enterprise module 220 analyzes only intelligently constructed sets of supplemental data.

The enterprise module 220 may analyze customer activity data in search of indications that the requested activity is abnormal for the customer, inconsistent with and/or apparently incompatible with other activity data generated by the customer's activities. When such indications are found, the enterprise module 220 may estimate an inferential strength with which these indications support a hypothesis that the requested activity is unauthorized. Additionally, the enterprise module 220 may further analyze the customer activity data for indications that the requested activity is normal for the customer, or consistent with, compatible with or explained by activity data generated by the customer's activities. Once these indications are found, the enterprise module 220 may estimate an inferential strength with which the indications contradict the hypothesis that the requested activity is unauthorized. The enterprise detection module 220 may then compare the contradictory inferential strength to the supportive inferential strength, and classify the requested activity as authorized or unauthorized, based on the comparison result.

Enterprise detection module 220 may employ any analytical method or combination of analytical methods to find indications that requested activity is abnormal for the customer, inconsistent with or unexplained by other customer activity data, and/or apparently incompatible with other customer activity data. As one example of the many such methods which may be used for detecting requested activity which is abnormal for the customer, the enterprise module 220 may detect that the requested activity data indicates that the request is occurring at a time of day at which the customer has infrequently initiated previous activity. As one example of the many such methods which may be used for detecting indications of inconsistent or incompatible data, the enterprise module 220 may detect that the requested activity data indicates that the request is connected with a store or location suspiciously far from another store or location at which recent activity involving the customer was registered.

Furthermore, enterprise detection module 220 may employ any analytical method or combination of analytical methods to find indications that requested activity is normal for the customer, consistent with and/or explained by other customer activity data, and/or compatible with other customer activity data. Enterprise detection module 220 may identify indications of normal activity by ascertaining common behaviors of the customer which are evidenced by the various activity data being analyzed. For example, the enterprise detection module 220 might classify a request, originating in Beijing, China, for a checking account withdrawal from the customer's account. In the course of making this classification, the enterprise detection module 220 could analyze historical credit card activity for the customer in order to ascertain whether the customer frequently travels to Asia. If analysis of the credit card data does indicate that the customer frequently travels to Asia, the enterprise detection module 220 could then determine that the credit card activity data provides an indication that the requested activity is normal for the customer.

One possible technique that the detection module may use to identify consistent, compatible, or explanatory information may involve analyzing independent sources of information in search of a same pattern of activity. For example, in an example scenario in which the enterprise detection module 220 classifies a customer's requested change of address associated with a bank account, the enterprise detection module 220 could look for a similar requested change of address depicted by credit card activity data and brokerage account activity data. If similar address changes are detected, the enterprise detection module 220 could determine that the brokerage and credit card information include data with which the requested activity is compatible and consistent. Additionally or alternatively, the enterprise detection module 220 could similarly analyze credit or brokerage supplemental data to determine whether account activity involving these services began occurring near the supposed new address at about the time of the address change.

The following paragraphs will describe example operations of system 200 to better explain how the previously described operational benefits are obtained. When a service is invoked (first, second, or third service) by a request for activity involving the customer's identity or access information, activity request data is promptly routed through network 201, and is inputted to the particular detection module 202, 204, or 206 trained to analyze requests invoking the requested service (the “classifying detection module”). In some cases, the activity request data may include data which is unique to the service invoked by the request. For example, when the request for activity is a requested credit card transaction, the activity request data may include a credit card account number, expiration data, or customer identity information provided as part of the activity request, a location (retail location, ATM location, computer terminal IP address), and/or dollar amount associated with the requested transaction, an event time, and/or any other relevant activity data.

Upon receiving the activity request invoking the customer's account, the classifying detection module 202, 204, or 206 accesses the customer's interpretive information residing in the particular data set (A, B, or C, hereinafter the “analyzed data set”) to which the classifying module has access. The classifying module 202, 204, or 206 then analyzes the activity request data in light of the customer interpretive information in order to classify the activity request as authorized or unauthorized, as well as to score the activity request.

If the classifying detection module 202, 204, or 206 classifies the requested activity as authorized, the requested activity is approved. If the detection module 202, 204, or 206 classifies the requested activity as unauthorized, the activity request is rejected. The fraud score is provided to the security measures decision module 280, which may use the fraud score and other information in the analyzed data set to determine if, in addition to the rejection of the request, stronger preliminary security measures are appropriate.

Regardless of the classification outcome, the requested activity data is also provided to the pre-enterprise filter 222. The pre-enterprise filter 222 filters the activity request data by determining whether the data should be reevaluated by the enterprise classification module 220. As part of the process of making this determination, the pre-enterprise filter 222 may access and evaluate the classification and score assigned by the classifying detection module 202, 204, or 206. However, the pre-enterprise filter 222 may also be configured to perform parallel filtering in which the classification and score is not involved in the filtering process which determines whether reevaluation of the activity request data is performed by enterprise filter 220.

If the pre-enterprise filter 222 blocks reevaluation of the requested activity classification by withholding the requested activity data from the enterprise detection module 220, the detection module 202, 204, or 206 classification is maintained. The requested activity data is then stored in the particular data storage structure 208, 210, or 212 that corresponds to the classifying detection module 202, 204, or 206, as the case may be. Furthermore, when the requested activity data is stored, it is labeled with the classification and score so that the data may later be applied intelligently to the analysis, classification, and scoring of future requested activity, as well as retraining or future performance analysis of the detection module that generated the classification and score.

In cases in which the classifying detection module 202, 204, or 206 makes an “unauthorized” classification which is maintained without reevaluation by the enterprise detection module 220, the security measures decision module 280 may consider the pre-enterprise filtering outcome in determining whether additional preliminary security measures should be imposed.

If the pre-enterprise filter 222 retains the activity request data, the retained data is forwarded to the enterprise detection module 220 so that it may generate its own classification and score. When the enterprise detection module 220 performs its analysis, it may directly access the particular data storage structure and customer interpretive data which the classifying module 202, 204, or 206 used to determine its classification.

The pre-enterprise filter 222 may employ any one or combination of several filtering methods or criteria for identifying requested activity data to retain for reevaluation by enterprise detection module 220. One such criteria may call for automatically retaining all activity request data involving more than a threshold amount of money, or depicting activity requested beyond a certain distance from a customer's address or at certain locations known to be associated with abnormal incidence of fraud.

Another method may involve applying data analysis rules developed using training data. In accordance with this disclosure, any number of simple or complex rules can be applied to filtering in this way, and the rules may involve multiple variables, variable ranges, and conditions. The rules may be general rules applied to all customers, or may be uniquely evaluated and chosen to be applied to specific customers. For example, a complex set of rules may be appropriate for a customer associated with high-dollar transactions, as good filtering performance in the case of high-value customers may have benefits which marginally outweigh the cost of any added computational complexity so necessitated. At the same time, a simpler set of rules may be appropriate to apply to a less-significant customer account, as the savings in complexity may enable high-value customer accounts to be more properly filtered.

Moreover, the pre-enterprise filter 222 may alternate between using several different sets of rules, such that the filter chooses which set to use depending on which of the first, second, or third service is invoked the activity request being filtered.

Moreover, in filtering requested activity data, the pre-enterprise filter 222 may use customer interpretive data from the data storage structure 208, 210, or 212 corresponding to the service invoked by the activity request. Thus, applying a filtering rule could involve evaluating activity request data in light of past activity request data invoking the same service.

Moreover, the pre-enterprise filter 222 could filter activity request data based solely on the classification and score given to the activity request data by the classifying detection module 202, 204, or 206. For example, the classification performance of any of detection modules 202, 204, and/or 206 can be approximated by testing the detection module(s) using activity request training data which depicts historical activity known to be unauthorized, and historical activity known to be authorized. Detection module classifications and corresponding scores made during this training period can be compared with the correct activity labels. A range of scores having the highest relative frequency of association with erroneous training classifications can be determined and stored as a vulnerable score range for the detection module.

Thereafter, when system 200 is used in production, the pre-enterprise filter references the vulnerable range of scores determined for the classifying detection module 202, 204, or 206. If the classifying detection module 202, 204, or 206 has scored the activity request data such that the score is within the vulnerable range, pre-enterprise filter 222 may retain the activity request data for reevaluation by enterprise detection module 220.

Also, before enterprise detection module 220 commences reevaluation analysis, the pre-enterprise filter 222 accesses supplemental data from the remaining two data sets not involved in the classifying detection module's analysis. For example, if the first detection module 202 is the classifying detection module, the pre-enterprise filter 222 accesses data set B and data set C, as these are the two data sets which are not accessed or used when the first detection module 202 performs classification and scoring. The pre-enterprise filter 222 filters the supplemental data by identifying data components of set B and set C which are expected to be informative in the reevaluation to be performed by detection module 220. Retained components of the supplemental data are then provided to the enterprise detection module 220.

As will be explained in greater detail in subsequent paragraphs, the pre-enterprise filter 222 may employ any one or combination of several filtering methods for identifying informative supplemental data components. One such method may involve identifying and retaining the supplemental data components which are most abnormal in view of any single criteria or combination of multiple criteria. This method may be understood with reference to an example hypothetical scenario involving pre-enterprise filtering of supplemental data depicting ATM or banking activity. In such a situation, if the vast majority of supplemental data depicted large daytime ATM withdrawals occurring on weekends, the pre-enterprise filter could identify and retain any supplemental data depicting small nighttime ATM withdrawals on a weekday.

Alternatively or additionally, the pre-enterprise filter 222 may evaluate the activity request data and filter the supplemental data so as to retain supplemental data components which are most consistent with the activity request data and/or components which are most inconsistent with the active request data. Supplemental data components which are consistent with requested activity are components which support a hypothesis that the requested activity is authorized. Supplemental data components which are inconsistent with requested activity are components which weigh against a hypothesis that the requested activity is authorized.

Inconsistent supplemental information may be most informative in the case of a “false-negative” classification (e.g. when a detection module 202, 204, or 206 erroneously classifies an activity request as authorized). One example of the many types of inconsistent supplemental data is data which, when considered alongside activity request data, reveals that the activity request took place at a location suspiciously far from a location at which other customer activity occurred. An explanatory hypothetical example could involve reevaluation of a seemingly routine, but nonetheless fraudulently requested credit card transaction at a department store close to the customer's residence. In this case, if supplemental data were to show that one hour before the credit card request, the customer made an in-person checking account deposit at a bank branch located 2,000 miles from that residence, this information would be informative for contradicting the false-negative hypothesis that the activity request data is legitimate. Because inconsistent information may be most informative and advantageous for correcting false-negative classifications, pre-enterprise filter 222 may be configured to most strongly favor retaining inconsistent supplemental information when a reevaluation of an authorized classification is to be performed.

Consistent supplemental information may be most informative when a “false-positive” classification (e.g. when a detection module 202, 204, or 206 erroneously classifies an activity request as unauthorized) is reevaluated by the enterprise detection module 220. An example of consistent supplemental information was previously provided in the example in which separate activity involving a customer's credit card, checking account, and brokerage account occurred at locations spaced closely together, far from the customer's residence. In that example scenario, the requested credit card activity could appear abnormal and suspicious under simple-efficient analysis performed by a detection module 202, 204, or 206. However, if the requested credit card activity were classified as unauthorized by detection module 202, 204, or 206, the checking and brokerage activity data would be informative as supplemental information weighing against the hypothesis of unauthorized activity. Because consistent information may be most informative and advantageous for correcting false-positive classifications, pre-enterprise filter 222 may be configured to most strongly favor retaining consistent supplemental information for a reevaluation of requested activity classified as unauthorized by the classifying detection module 202, 204, or 206.

Pre-enterprise filter 222 may also employ any number, combination or combinations of analytical methodologies, logical rules, and/or heuristics for retaining supplemental data which is consistent and/or inconsistent with activity request data. The following examples will provide only a few of the numerous ways in which a pre-enterprise filter 222 can be configured to apply filtering logic to this end. As one example, the pre-enterprise filter 222 can apply a time stamp analysis such that if activity request data indicates requested late night or early morning activity, supplemental data depicting other late night or early morning activity may be retained by the pre-enterprise filter. As another example, if requested activity data suggests an abnormally high use of ATMs the pre-enterprise filter 222 may retain any supplemental data indicating that the customer may be in a part of the world where credit and debit cards are rarely accepted for use. Another possible filtering mechanism could involve applying consumption comparisons. For example, in response to requested activity data indicating an abnormally large credit card purchase, the pre-enterprise filter 222 could retain supplemental data indicating that the customer may also be withdrawing cash at an abnormally high rate. Furthermore, when activity requests propose a payment or transfer of funds to a business, the pre-enterprise filter 222 can operate to filter supplemental data by retaining any supplemental data depicting a different form of payment or funds transfer to the same business or another entity similar to it, or supplemental data depicting a cancelled recurring payment to such an entity or business.

Additionally, pre-enterprise filter 222 may be configured to provide filtering of supplemental data in a manner customized to the preferences of the entity which operates system 200. Different entities may have different relative preferences for avoiding false-positive detections, achieving true-positive detections, and minimizing the processing or computational demands entailed by operating system 200. An entity's relative preferences may depend on its business model, the characteristics of its clients, its exposure to criminal activity, its appetite for risk, or a host of other possible factors. For example, an entity which has experienced minimal exposure to criminal activity and which calculates that it is heavily prejudiced by false-positive detections could desire to emphasize false-positive avoidance over enhancing true-positive detection performance. For this reason, system 200 enables the entity to input filter settings, as depicted at 250.

Filter settings may be defined generally to all customers and all transactions, or may be customized with respect to certain customers, groups of customers, and types of transactions. For example, an entity may input settings indicating a low tolerance for false-positives in the event of large transactions, and a higher-tolerance for false-positives in the event of small transactions.

The pre-enterprise filter 222 may access the inputted filter settings and adjust the filtering of supplemental information based on the settings. As mentioned previously, in many cases, supplemental information that is consistent with requested activity data may be most informative when applied towards reevaluating activity requests initially classified as unauthorized (i.e., activity requests resulting in an initial classification that may be false-positive). Accordingly, when a newly inputted filter setting indicates that the entity is increasingly concerned about minimizing false-positive detections, the pre-enterprise filter 222 modifies its analytics or heuristics so that the categorization of consistent supplemental data is liberalized.

Similarly, when an inputted filter setting indicates that the entity is increasingly concerned with enhancing true-positive detection, and is relatively unconcerned about false-positives, the pre-enterprise filter 222 modifies its analytics or heuristics so that the categorization of inconsistent supplemental data is liberalized, and so that the categorization of consistent supplemental data is made more selective.

FIG. 3 is an exemplary and generalized depiction of pre-enterprise filtering and enterprise scoring module operations within a detection system 200 embodying certain aspects of the present disclosure. FIG. 3 is meant only to depict only general operating characteristics and principles for explanatory purposes only, without limiting the scope of the disclosure in any way. As such, specific algorithms or analytics will not be mentioned in the following discussion of FIG. 3. Rather, the steps and outcomes in FIG. 3 are to be understood as generally illustrative of concepts and methodologies previously discussed herein. Moreover, this disclosure shall be understood to cover other detection systems 200 having operating characteristics which may differ in any number of ways from the operating characteristics shown in FIG. 3.

As depicted in FIG. 3, when a submitted activity request invokes the customer's credit card account, a simple-efficient detection module 202 (or 204, 206) analyzes the activity request data 304 generated in response to the request. Detection module 202 analyzes each instance of activity request data in conjunction with the customer credit card interpretive data in data set A (not shown in FIG. 3). As shown, activity request data 304 includes a description of the business establishment linked to the requested activity 306. The activity request data also depicts an amount of money invoked by the request for activity 308, a timestamp 310, and an indication of the distance from the customer's residence of the activity request origination location 312.

As depicted at 330, detection module 202 analyzes a request for credit card activity made at a casino and classifies this request as unauthorized based on the requested activity data and customer credit card interpretive data (not shown). Furthermore, detection module 202 assigns a very high fraud score 339 to the casino credit card activity request. The detection module 202 also analyzes all other depicted credit card activity requests and classifies each of these requests as authorized. The requests preliminarily classified as authorized include a request associated with an overseas jewelry website and activity request data associated with a sports store. No specific depiction of these classifications is shown in the figure. Instead, the classifications of these requests as authorized is implicitly depicted by these activity requests not being shown within the “classified as unauthorized” box shown at 330.

Pre-enterprise filter 222 filters each instance of credit card activity request data to intelligently limit the activity request data reviewed by enterprise detection module 220. As implied by the fact that no fraud scores are attached to the activity request data retained by pre-enterprise filter 222, the particular pre-enterprise filter 222 of FIG. 3 filters activity request data without considering or evaluating the fraud scores provided by detection module 202. That is, detection module 202 classification and pre-enterprise filtering are independent processes. However, in other detection system implementations within the scope of the present disclosure, pre-enterprise filter 222 may filter activity request data by considering or evaluating fraud scores, and may even use fraud scores as the exclusive filtering criteria.

It should be noted that in FIG. 3, pre-enterprise filter 222 is depicted at two separate locations—once with respect to the credit card data, and once with respect to the supplemental data at the bottom of the page. However, this dual depiction shall not be interpreted to mean that a pre-enterprise filter must comprise two separate or isolated parts or components. While this disclosure shall be understood to cover systems in which pre-enterprise filter is implemented using more than one processor, memory source, server, or the like, such an arrangement is only one of the many ways in which a pre-enterprise filter 222 may be implemented in accordance with this disclosure. The dual depiction in FIG. 3 is provided only because of the ease of depicting the pre-enterprise filter in this way, and is intended only to show that the pre-enterprise filter may be applied to multiple streams of data, each of which represents activity involving a different service.

As is further depicted in FIG. 3, pre-enterprise filter 222 filters the casino activity request data but does not retain it, thereby preventing this instance of requested activity from being evaluated by enterprise detection module 220. However, pre-enterprise filter 222 does retain activity request data associated with a transaction requested at a sports store 1,919 miles from the customer's home. This request was classified as authorized by detection module 202.

Additionally, when a submitted activity request invokes the customer's checking account information, detection module 204 analyzes the activity request data generated in response to that request. This activity request data also includes data depicting the date or time of the request, precise type of activity requested (i.e. check deposit, ATM withdrawal, etc.), the distance from the customer's residence of the activity request, and the amount of money involved in the request. As shown at 360, detection module 204 classifies each of the depicted checking account activity requests as authorized.

Pre-enterprise filter 222 filters the checking account activity request data. Here, the pre-enterprise filtering of checking account data is dual-phased. The checking account data is filtered initially to prevent inefficient enterprise detection module 220 reevaluation of activity request data. This initial filtering is not explicitly depicted in FIG. 3. The lack of an explicit depiction is intended to imply that in the example sequence of processing operations illustrated by FIG. 3, the filtering does not result in any checking account activity request data being retained for enterprise detection module 220 reevaluation. The requested activity data then becomes part of the customer's checking account activity history, whereupon, as depicted in FIG. 3, it is again filtered to determine whether it includes informative supplemental data components for use in reevaluating credit card activity request data 304.

As depicted, pre-enterprise filter 222 retains components depicting check depositing activity on Apr. 10, 2012 and Apr. 19, 2012 after determining that these components are likely to be informative for reevaluating the credit card activity request involving the sports store and overseas jewelry website. Accordingly, these retained supplemental components are provided to enterprise detection module 220.

Enterprise detection module 220 reevaluates the requested credit card activity data of Apr. 20, 2012, along with consistent supplemental data depicting the deposited checks on Apr. 10 and Apr. 19, 2012. The information provided by the consistent supplemental data implies that the April 20 activity request may be legitimate, and enterprise detection module 220 does ultimately classify this activity as authorized, as depicted at 370. Because the requested activity of April 20 was initially classified as authorized by detection module 202, no security measures were initiated in response to the initial classification. Thus FIG. 3 should be understood as implying that the Apr. 20, 2012 activity request data is simply added to the customer credit card interpretive data set within data storage structure 208.

FIG. 4 displays example operations of a detection system 200 which operates similarly to the detection system 200 of FIG. 3, but which has certain unique operational attributes. For example, as depicted in FIG. 4, the pre-enterprise filter 222 evaluates detection module 202 fraud scores as part of filtering activity request data. This is shown by the fraud scores 434 and 438, which are provided to the pre-enterprise filter 222 via communication path 421, and are accompanied by the activity request data to which they relate. In this arrangement, fraud scores for activity requests classified as authorized by detection module 202 may also be provided to, and evaluated by pre-enterprise filter 222. However, as FIG. 4 does not specifically depict the classification results of the activity requests, the fraud scores associated with these results are not depicted as being provided to pre-enterprise filter 222.

As depicted in FIG. 4, the requested credit card activity involving the sports store is initially classified as unauthorized by the detection module 202. Accordingly, this requested activity is initially rejected and security measures may be imposed at the time of this initial classification. Also, FIG. 4 illustrates an example of results that may be obtained when the pre-enterprise filtering of requested activity data involves comparing the detection module 202 fraud scores to a scoring range within which there is a high likelihood of detection module classification error. As described previously, this type of score range may be ascertained in a training phase by using a detection module to classify and score requested activity training data with known labels.

In FIG. 4, the chart at 408 displays examples of such score ranges for detection module 202. As shown in the chart, classification of training data by detection module 202 has revealed that there is significantly elevated probability of erroneous classification in the case of any requested activity triggering a medium or high detection module 202 scoring. Also, instances of requested activity which do not trigger a score within this range are unlikely to be erroneously classified. Thus, the range of fraud scores from 400-600 (e.g. medium-high) may be defined as the likely error range of detection module 202.

The use of the score range for filtering may be understood with reference to the pre-enterprise filter 222 rejection of the activity request data associated with the casino, as compared to the pre-enterprise filter retention 222 of the activity request data associated with the sports store. In the case of the data associated with the sports store, the pre-enterprise filter 222 considers the high detection module 202 fraud score which this data triggered. Because a high fraud score is within the detection module 202 likely error range, the pre-enterprise filter 222 interprets the fraud score as a factor weighing in favor of retaining the requested activity which triggered that score. As shown, based on both this factor as well as other considerations (i.e., other relevant logical rules, filtering parameters, heuristics, etc.), the pre-enterprise filter retains the requested activity data involving sports equipment so that it may be reevaluated by the enterprise detection module 220.

Conversely, in the case of the data associated with the casino, the pre-enterprise filter 222 considers the very high detection module 202 fraud score which this data triggered. Because a very high fraud score is not within the detection module 202 likely error range, the pre-enterprise filter 222 interprets this fraud score as a factor weighing against retention of the requested activity data to which it corresponds. As shown, based on both this factor, as well as other considerations, the pre-enterprise filter 222 rejects the requested activity data involving the casino so that it will not be unnecessarily reevaluated by the enterprise detection module 220.

Because the requested activity data involving the casino is not reevaluated, the initial classification is maintained. In this way, the pre-enterprise filter 222 decision to not retain this instance of activity data is a confirmation that its initial classification by the detection module 202 is likely to be accurate. Accordingly, additional security measures affecting the customer's credit card account may be activated in response to the pre-enterprise filter 222 decision.

FIG. 4 further depicts that in response to retaining the requested credit card activity data related to the sports store, the pre-enterprise filter 222 filters the customer's checking account activity data so as to identify supplemental components of this data which are likely to be informative for the enterprise module 220 in reevaluating the requested credit card activity data. In this process, pre-enterprise filter 222 retains components depicting check depositing activity on Apr. 10, 2012 and Apr. 11, 2012 after determining that these components are likely to be informative for reevaluating the credit card activity request involving the sports store. Accordingly, these retained supplemental components are provided to enterprise scoring module 220.

Enterprise detection module 220 classifies the requested sports store credit card activity in light of the consistent supplemental information provided by the data components depicting the check deposit on Apr. 20, 2012. Although not specifically depicted, the enterprise module 220, in determining the appropriate classification, may analyze any information or data within the credit card interpretive dataset stored for the customer, in addition to the requested activity data, and the supplemental checking account data. As depicted, the enterprise detection module 220, based on its analysis of multiple sources of information, determines that the requested sports store credit card activity is authorized.

Because this instance of requested credit card activity had previously been classified as unauthorized by detection module 202, the enterprise module 220 classification reverses the previous classification. For this reason, security measures decision module 280 (not shown in FIG. 4) responds to the enterprise detection module 220 classification by deactivating (not depicted) any security measures which were previously imposed in response to the initial detection module 202 classification.

Enterprise detection module 220 also reevaluates the requested credit card activity data of Apr. 20, 2012, along with inconsistent supplemental data depicting the deposited check on Apr. 20, 2012. The information provided by the inconsistent supplemental data implies that the April 20 activity request may not be legitimate, and, as depicted at 372, enterprise detection module 220 does ultimately classify this activity as unauthorized. In response to this ultimate classification, security measures affecting at least the customer's credit card account may be imposed.

It should be noted that in FIG. 4, pre-enterprise filter 222 is depicted at two separate locations—once with respect to the credit card data, and once with respect to the supplemental data at the bottom of the page. However, this dual depiction shall not be interpreted to mean that a pre-enterprise filter must comprise two separate or isolated parts or components, nor that it must be implemented by separate processors or instructions stored at separate locations. While this disclosure shall be understood to cover systems in which pre-enterprise filter is implemented using more than one processor, memory source, server, or the like, such an arrangement is only one of the many ways in which a pre-enterprise filter 222 may be implemented in accordance with this disclosure. The dual depiction in FIG. 4 is provided only because of the ease of depicting the pre-enterprise filter in this way, and is intended only to show that the pre-enterprise filter may be applied to multiple streams of data, each of which represents activity involving a different service.

FIG. 5 is a flow diagram depicting example processes of a detection system operating in accordance with the techniques of the present disclosure. The flow diagram begins at 502, when a request for activity is received. At 502, the depicted request is a request for activity that would involve a first service provided to a customer under the monitoring of a system such as detection system 200. At 504, system 200 determines the customer account invoked by the request. At 506, customer interpretive information stored with respect to the account holder is accessed by a simple-efficient detection module used to classify activity requests involving the first service. The simple-efficient detection module also accesses historical data depicting the usage and activity history related to the invoked account.

At 508, the detection module uses the information accessed at 506 in order to classify and score the request for activity received at 502. At 510, the process depends on the classification made by the detection module. If the request for activity is given an “authorized” classification, the requested activity is processed at 512. Processing the requested activity may involve transmitting network communications to indicate that the requested activity has been approved.

If, however, the request for activity is given an unauthorized classification at 510, a rejection message is sent using network communications, as depicted at 514. At 516, security measures module 280 (depicted in FIG. 2) determines whether additional preliminary security measures are appropriate. This determination may be based on the fraud score assigned to the rejected request for activity and the average rate of erroneous detection module error associated with the score.

If it is determined that additional security measures are warranted, then at 518, the security measures module updates the customer account invoked by the rejected request so that the account reflects the additional security measures.

Regardless of whether the requested activity was classified as authorized or unauthorized, the customer account invoked by the request is updated at 520 to reflect the most recent activity request data received at 502, and the classification made by the detection module at 508. At 522, the pre-enterprise filter is used to filter the activity request data. This filtering involves determining whether the enterprise detection module 220 (depicted in FIG. 2) should be used to classify the request for activity depicted by the data.

At 524, subsequent processes depend on the previous pre-enterprise filtering decision. If the pre-enterprise filtering decision is that enterprise module classification of the requested activity should not be performed and the detection module classification was “unauthorized,” security measures module 280 (depicted in FIG. 2) evaluates the current security measures at 526 and strengthens them as needed. Next, at 528, system 200 updates the customer account historical data and customer interpretive information to reflect that an “unauthorized” classification is ultimately assigned to the requested activity. If the pre-enterprise filtering decision is that enterprise module classification of the requested activity should not be performed and the previous detection module classification was “authorized,” detection system 200 updates the customer account historical data and customer interpretive information to reflect that an “authorized” classification is ultimately assigned to the requested activity. This updating step is depicted at 530.

If, at 524, the pre-enterprise filter determines that the enterprise module should classify the requested activity, then the pre-enterprise filter additionally filters supplemental data depicting the use of a second service by the accountholders associated with the first service account. The pre-enterprise filter determines a portion of this supplemental data to provide to the enterprise classification module. This filtering step is depicted at 532.

Subsequently, at 534, the enterprise module classification of the activity request is determined. If the classification is that the activity request is unauthorized, the security measures module 280 evaluates the current security measures and determines if the security measures should be strengthened in light of the enterprise module classification, as depicted at 526. Also, historical data and customer interpretive data associated with the customer account are updated to reflect the security measures and the ultimate “unauthorized” classification, as depicted at 528.

Alternatively, if the enterprise detection module 220 classifies the requested activity as “authorized” at 534, and the previous detection module 202, 204, or 206 classification was “unauthorized”, the security measures module 280 deactivates the now-unnecessary security measures at 536 and, at 537, updates the customer activity history and interpretive information to reflect the ultimate “authorized” classification. Although in this case, it may be too late for the requested activity to be processed, the improved labeling provided by enterprise detection module 220 may prevent unnecessary security measures from being imposed, and also prevent future incorrect classifications from being made by the detection module 202, 204, or 206.

FIG. 6 is an example flow diagram depicting certain generalized processes 600 for training, implementing, and using an unauthorized activity detection system 200 that incorporates components similar to an enterprise scoring module 220 and pre-enterprise filtering module 222. The process of FIG. 6 may be used by an entity which utilizes an enterprise scoring module to detect unauthorized debit card activity involving the account of a customer who also obtains an additional service from the entity.

Process 600, beginning at 602, involves using historical debit card transaction data and debit card detection module 202, 204, or 206 performance data to identify common characteristics of debit card activity linked to an incorrect debit card detection module 202, 204, or 206 classification. At 604, these identified characteristics are used to formulate requested activity data filtering rules for identifying requested debit card activity likely to be connected with a false debit card detection module classification. One example of such a rule was discussed previously, with reference to FIG. 4, in which a detection module score range associated with relatively high probability of detection module errors was used. In the case of process 600, the rule may provide for the retention of debit card activity data which triggers a score within a certain range. The range may be ascertained in the training phase by scoring and classifying various instances of historical debit card activity request data, and identifying a range encompassing scores most likely to accompany an erroneous classification.

Rules for filtering debit card activity may be chosen in other ways as well. For example, within a training data set, instances of historical debit card activity request data may be partitioned based on one or more variables. A highly-simplified partitioning will be discussed herein for exemplary and explanatory purposes. Such a partitioning may involve forming two groups of historical debit card activity request data such that a first group includes all data depicting requested activity involving more than a threshold amount of money, while the second group includes all data depicting requested activity involving less than a threshold amount of money. Subsequently, while still in the training phase, the debit card detection module may be used to classify each instance of requested activity data in the training set. The classification performance of the detection module with respect to the first group of debit card activity request data may be compared with the module's performance with respect to the second group of debit card activity request data.

If the detection module classification of the data in the second group is better than its classification of the data in the first group, then the threshold may be used in a filtering rule so as to reject requested debit card activity data involving less than the threshold amount of money. Conversely, if the detection module classification of the data in the first group is better than its classification of the data in the second group, then the threshold may be used as a filtering rule so as to reject requested debit card activity data involving more than the threshold amount of money.

Process 600 further includes accessing production phase debit card activity request data, as shown at 606. Subsequently, at 608, a debit card fraud detection module (e.g. detection module 202, 204 or 206) is used to classify debit card activity request data. As mentioned previously, a detection module 202, 204 or 206 may analyze the customer debit card interpretive data set (for example, the set of data stored at 208, 210, 212) in the process of making each classification.

At 610, the filtering rules determined at 604 are applied by a pre-enterprise filter 222. The pre-enterprise filter 222 applies the filtering rules to the instance of debit card activity request data classified at 608. At 610, the filtering rules enable the pre-enterprise filter 222 to determine whether the instance of debit card activity request data will be retained. This determination is indicated at 612.

If the pre-enterprise filter retains the debit card activity request data for enterprise detection module reevaluation, as indicated by the YES branching from 612, the enterprise module reevaluates the debit card activity request data by analyzing the activity request data in conjunction with activity data depicting the customer's use of the additional service which the entity provides, as shown at 614. If the pre-enterprise filter rejects the debit card activity request data for enterprise detection module reevaluation as indicated by the NO branching from 612, the process reverts again to step 606. Subsequently, the process may continue through subsequent iterations for so long as debit card activity requests from the customer continue to be made.

FIG. 7 depicts an algorithm based on a more complex methodology for jointly determining supplemental data filtering rules and requested activity data filtering rules to be used by the pre-enterprise filter 222. The joint setting of rules may be accomplished during the training phase so as to obtain a synergistic combination of rules. In accordance with the rule determination methods of FIG. 7, many candidate rule combinations may be separately tested and analyzed by operating a detection system in the training phase with the rule combinations applied. Testing a combination of filtering rules may be done by filtering the training data using the filtering rule combination, providing the retained training data components to the enterprise detection module 220, and then analyzing the true-positive and false-positive system detection rates occasioned by application of the rule combination. Also, the computation speed and processing resources required by each rule combination may be studied. In this way, the analysis of various rule combinations may enable the selection of a combination which is anticipated to provide detection results which are consistent with the operating entity's relative preferences for true-positive detection, false-positive avoidance, and computational efficiency.

FIG. 7 shows how the joint rule selection algorithm is applied to select a combination of rules for pre-enterprise filtering of a customer's credit card activity request data in conjunction with pre-enterprise filtering of supplemental data depicting the customer's ATM activity history. However, the techniques, steps and processes of FIG. 7 are not limited to this particular evaluation scenario or combination of data sources. The algorithm may be easily adapted for selecting a combination of filtering rules for performing pre-enterprise data filtering of data from any number or type of customer service data sources. Thus, as an one example, the depicted algorithm could be applied towards selecting a combination of rules for pre-enterprise filtering of a customer's ATM activity request data in conjunction with pre-enterprise filtering of supplemental data depicting the customer's debit card activity history and additional supplemental data depicting the customer's brokerage account activity history.

Moreover, any particular execution of the algorithm depicted in FIG. 7 may directed to setting pre-enterprise filtering rules for detecting unauthorized activity with respect to the account of a single customer or the accounts of customers in a group. Thus, the algorithm depicted in FIG. 7 may be separately applied with respect to each of multiple customers. In this case, an entity using detection system 200 may execute the algorithm once for each customer having an account monitored by the detection system. Each execution of the algorithm may involve using the algorithm in conjunction with historical training data which is determined to be specifically relevant to the respective customer.

Alternatively, a particular execution of the algorithm may be directed to setting a rule combination to be applied to the activity request data of several customer accounts. In this case, the entity using detection system 200 may execute the algorithm once for the group of accounts. The execution of the algorithm may be done in conjunction with historical training data which is determined to be specifically relevant to the accounts in the group, generally.

As depicted, algorithm 700 involves accessing K candidate rules {CCRULE₁, CCRULE₂, . . . , CCRULE_{K}} for pre-enterprise credit card requested activity data filtering. These candidate rules may be filtering rules such as were described previously with regards to FIG. 6. The rules may be simple or complex, and may involve any number of conditions, logical relationships, activity data variables, or mathematical formulas. An example candidate filtering rule may be a rule which dictates retaining only instances of requested activity data connected with activity requested at a certain time of day (e.g., activity requests meeting a time of day condition involving a range of hours) and involving more than a threshold amount of money (e.g., activity satisfying a dollar amount condition). Alternatively, a slightly more complex candidate rule could dictate retaining requested activity data meeting the time of day and dollar amount conditions, and also indicating a request originating more than a threshold distance from the customer's home address. Additionally, the number of rules (K) may be any number greater than one.

As depicted at 704, the algorithm next involves accessing K candidate rules {ATMRULE₁, ATMRULE₂, . . . , ATMRULE_{K}} for pre-enterprise filtering of supplemental ATM activity data. In this step, candidate rules may be rules created in any manner, and also may incorporate any number or type of conditions, logical relationships, activity data variables, or mathematical formulas. In FIG. 7, K candidate rules are accessed both at 702 and 704, such that the sets of candidate rules are the same size. However, at 704 it is also possible to determine a number of candidate rules which differs from the number of candidate rules determined at 702.

Subsequently, at 706, historical credit card training data is accessed. The credit card training data may include known labels for each instance of historical activity request data in the set. That is, the training data set may include only data generated in response to activity requests which were investigated and reliably determined to have been authorized or unauthorized (e.g., after classification, requests for activity often can be reliably determined to be authorized or unauthorized based on information from a subsequent investigation, customer verification, merchant verification, legal evidence, etc.). The training set includes information about these ultimate determinations.

The credit card training data may be credit card activity data previously analyzed by the particular detection module 202, 204, or 206 within system 200 that is used to analyze requested credit card activity (hereinafter, for the purposes of the discussion of FIG. 7, this particular module will be referred to as the “credit card detection module”). Moreover, when this is the case, each instance of the training data may be accompanied by the credit card detection module classification which it triggered, and an indication as to whether the instance was ultimately determined to involve authorized or unauthorized activity.

Also, the credit card training data may be chosen to include past credit card activity request data deemed most relevant to the credit card account(s) to be monitored using the filtering rule combination. For example, in an example scenario in which the algorithm is used to identify a rule combination which will be applied to monitoring the credit card accounts of wealthy senior citizens, the accessed credit card training data may be previous activity request data which involved the accounts of other wealthy senior citizens. Alternatively, in a different example scenario in which the algorithm is used to identify a rule combination for use in monitoring the accounts of families with a moderate credit limit, the training data may be activity request data which involved the accounts of other families having a similar credit limit.

At 708, the performance of the credit card detection module is determined with respect to the credit card training data. In the case in which the training data was previously analyzed by the credit card detection module, the determination may involve calculating the number of true positive classifications, true negative classifications, false positive classifications and false negative classifications. These numbers may be calculated by reviewing, for each instance of activity request training data, how the classification compared to the ultimate authorized/unauthorized determination. For example, a false positive detection is tallied in each case of an instance of activity request training data which triggered an unauthorized classification but was ultimately labeled as authorized. A true negative detection is tallied in each case of an instance of activity request training data which triggered an authorized classification and was ultimately labeled as authorized.

On the other hand, if the training data was not previously analyzed by the credit card detection module, the credit card detection module performance may be determined by inputting the training data set to the module so that it may classify each instance of activity request data in the set. After each instance has been classified, the classifications may be determined to be true positive, true negative, false positive, or false negative based on comparing the classifications to the authorized/unauthorized labels determined for the instances of activity request data.

Next at 710, historical training data depicting ATM activity data is accessed. Much like the credit card activity request training data, the ATM activity data may be chosen to include past ATM activity data deemed most relevant to analysis of the particular credit card account(s) which will be monitored using the filtering rule combination.

At 712, the testing of filtering rule combinations begins. The first step in testing rule combinations is depicted at 714. At 714, a first count variable (a) and a second count variable (b) are each initialized to 1. Subsequently, an iterative process begins in which different combinations of filtering rules are tested. For example, at 716, the set of ATM training data is filtered using ATMRULEₐ. Each ATM training data component meeting the retention condition of ATMRULEₐ is retained.

Next, at 718, the set of credit card activity request training data is filtered using CCRULE_{b}. Each instance of credit card activity request data meeting the retention condition of CCRULE_{b} is retained. At 720, the retained ATM training data components and the retained instances of credit card activity request data are provided to the enterprise scoring module 220 so that the enterprise detection module may be tested in conjunction with pre-enterprise filtering based on ATMRULEₐ and CCRULE_{b}. The enterprise detection module 220 evaluates each instance of credit card activity request data in light of the ATM training data components with which it is also provided. Based on these evaluations, the enterprise detection module 220 classifies each instance of credit card activity as authorized or unauthorized. This classification process is depicted at 722. At 724, these enterprise detection module 220 classifications are then individually compared to the known authorized/unauthorized labels accompanying each instance of credit card activity request data in the credit card training data set.

Based on these comparisons, each enterprise module classification can be recorded as either a true negative, false negative, false positive, or true positive classification. Moreover, as depicted at 726, these results can then be saved in a data table and labeled based on the rule so that later they can be compared with the enterprise detection module classification results recorded for other rule combinations.

At 728, the second counter variable (b) is compared to k (the number of ATM filtering rules and the number of credit card filtering rules). If b is less than k, a following iteration of steps 718-728 is commenced after incrementing b at 730. Incrementing b at 730 results in a new credit card data filtering rule (CCRULE_{b}) being tested in conjunction with the previously-tested ATM supplemental data filtering rule during the following iteration. Subsequent similar iterations of steps 718-728 are then progressively performed until b is not less than k (i.e., when b first equals k), at 728.

Once b is not less than k at 728, a is incremented and b is set equal to 1, as shown at 732. At 734, a is compared to k. For so long as a does not exceed k at 734, the steps 716-734 are iteratively executed such that each iteration of steps 716-734 includes k nested iterations of steps 718-730, in the manner described previously. Iteratively incrementing a at 732 enables new candidate ATM filtering rules to be tested in combination with each candidate credit card filtering rule.

When a exceeds k at 734, every pairwise combination of credit card and ATM candidate rules has been tested. Thus, at 736 the detection data table is analyzed to determine which rule combination was associated with the best training data detection performance. As will be explained subsequently with respect to FIG. 8, analyzing the detection table may involve considering the false-positive detection rate and true-positive detection rate indicated by the training data trials with the various rule combinations. This analysis may also involve analyzing the computational resources necessitated by each combination of rules, as well as weighing the operator's preferences for avoiding false positive detection, achieving true positive detection, and conserving computational resources.

At 738, after a best filtering rule is identified, the filtering rule is retained for use in pre-enterprise filtering of credit card activity data and supplemental ATM activity data.

FIG. 8 depicts an example detection table 800 provided to depict how a table may be generated during a pre-enterprise filtering rule combination trial involving training data. Specifically, FIG. 8 is intended to depict how table 800 may be generated when the trial involves testing system 200 using a training data set consisting of credit card activity requests with known authorized/unauthorized labels, and supplemental ATM activity data from the accounts of clients' credit card accounts were involved in the activity requests.

The table 800 may be understood to document results of a rule combination trial for testing the classification performance of system 200 by separately evaluating the system's performance when using each of multiple candidate filtering rule combinations. Thus, a table such as the one depicted at 800 may be generated by the testing process of FIG. 7, or any other similar rule combination trial involving the tabulation of detection module 202, 204, or 206 pre-enterprise filter and enterprise detection module responses to multiple instances of activity request training data and supplemental data related to a first and second service, respectively.

As depicted, detection table 800 is a tabulation of classification results obtained by separately applying each of 7 unique combinations of credit card and ATM pre-enterprise filtering rules to a pre-enterprise filter while using system 200 to classify historical requested credit card activity documented by a sample of activity request training data. Although it is possible to form 9 unique combinations of the rules depicted in table 800, only 7 such combinations have been shown for brevity. Although not depicted, it should understood that during each of the tabulated trials, the pre-enterprise filter and the enterprise detection module used supplemental ATM activity data from the bank accounts of customers whose credit card accounts were involved in the credit card activity requests. Each row of the table shows the distribution of classification outcomes resulting from the use of a respective rule combination in the process of classifying 6,000 instances of credit card activity requests in the training data sample

For example, at 802 the table depicts a rule combination associated with the distribution of classification results in the table's bottom row. Rule combination 802 is a combination of credit card filtering rule CCRULE₃ and ATM filtering Rule ATMRULE₁. The detection data at 852 depicts the distribution of classification outcomes resulting from using rule combination 802 as the pre-enterprise filtering criteria during the trial classifications of the credit card activity requests in the training data.

Classification category key 854 explains and defines the classification outcome categories (A-L) used to depict the classification outcome distributions resulting from use of the evaluated rule combinations. As may be understood with reference to 854, each classification category is a unique combination of a detection module classification result (i.e., true-positive, false-positive, true-negative, or false-negative) with respect to an analyzed request for activity, and a pre-enterprise filtering decision (i.e., enterprise module will/won't classify the activity request) with respect to the request. Furthermore, with regards to the categories (A-H) defined with respect to a pre-enterprise filtering decision to allow enterprise module classification, each of these categories is further defined with respect to an enterprise module classification result (i.e., true-positive, false-positive, true-negative, or false-negative) following the filtering. Thus, for example, category A categorizes all instances of authorized credit card activity correctly classified by the credit card module, but incorrectly classified by the enterprise detection module following pre-enterprise filtering of the activity request data and accompanying supplemental data. Because system 200 operates by ultimately maintaining all classifications made by the enterprise detection module, a false positive classification is the final classification result for each classification within category A.

As an additional example, category L is defined to include all instances of credit card activity known to be authorized which are incorrectly classified by the detection module, and are not classified by enterprise detection module due to a pre-enterprise filtering decision to that effect. Because system 200 operates by maintaining all detection module classifications of requested activity for which no enterprise detection module classification is made, a false positive classification is the final classification result for each classification within category L.

Although not all of the classification categories A-L will be individually discussed beyond the explanation provided in the category key 854 and in the discussion above, it is worth mentioning that when an evaluated rule combination is applied to classify credit card activity known to have been unauthorized, the classification category must always be either category C, D, E, F, J or K, as these categories together include all of the possible ways that a false negative or true positive final detection result can occur. Alternatively, when an authorized credit card transaction is classified by system 200, the classification category must be either A, B, G, H, I, or L, as these categories together include all of the possible ways that a true negative or false positive final detection result can occur.

As depicted in FIG. 8, 6,000 requested credit card transactions were depicted by the training data sample to which each filtering rule combination was applied. This fact is depicted at 804 and 806, which indicate that 4500 negatives (i.e., instances of authorized credit card activity) and 1500 positives (i.e., instances of unauthorized credit card activity) were included in the training data set (4500 negative training data samples+1500 positive training data samples=6000 total training data samples) to which the various rule combinations were applied.

The column at 880 depicts the true positive detection rates achieved by system 200 when the seven candidate combinations of pre-enterprise filtering rules were used. A true-positive detection rate is the percentage of positives in the sample which were correctly classified by system 200. Thus, for any rule combination, the true-positive detection rate is computed by summing the classifications in categories C, F, and K, and dividing this sum by the total number of positives in the sample (i.e., 1500).

The false-positive detection rate is the percentage of negatives in the sample which were classified incorrectly. Thus, the false-positive detection rate is computed by summing the classifications in categories A, G, and L, and dividing this sum by the total number of negatives (i.e., 4500).

By analyzing the false positive detection rate and the true positive detection rate occasioned by each of the filtering rule combinations, an operating entity may select a filtering rule combination which can be expected to perform best in accordance with the operating entity's preferences.

Additionally, although not depicted, it may be advantageous to evaluate the computational resource consumption of the enterprise scoring module occasioned by usage of the various pre-enterprise filtering rule combinations. This evaluation may be especially desirable for an entity which intends to use the enterprise detection module to analyze activity request data for each of several different services, and thus needs to efficiently schedule resource consumption with respect to each individual service to which the enterprise module is applied. A simple way to determine an approximate resource consumption for a filtering rule combination is by determining the total number of classifications distributed amongst classification categories A-H. That is, the overall number of classifications performed by the enterprise detection module may be used to approximate the module's resource consumption.

FIG. 9 displays example sequences of security measure responses which may be taken by security measures module when system 200 is used in an operational setting. As depicted in FIG. 9, in each of the example sequences, activity request data is initially classified by a detection module 202, 204, or 206. If the detection module 202, 204, or 206 classifies the requested activity as “authorized,” the security measures module allows the requested activity to take place. If the detection module 202, 204, or 206 classifies the requested activity as unauthorized, the activity is blocked and basic security measures are imposed. As depicted at 906, pre-enterprise filter also evaluates the data generated by each activity request to determine if further evaluation and classification by the enterprise detection module 220 is appropriate.

As depicted at 908, when a detection module classifies a request for activity as unauthorized and pre-enterprise filter determines that further evaluation is not appropriate, the initial classification is maintained. In this case, the security measures module may impose additional security measures because the pre-enterprise filter decision provides some confirmation that the initial classification was accurately made.

Additionally, as depicted at 910, any classifications made by the enterprise detection module are treated as the ultimate classification of system 200. Thus, the security measures module may increase security measures to a strongest level when enterprise module classifies a transaction as unauthorized.

The methods, systems, devices, implementations, and embodiments discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the current disclosure. Also, a number of steps may be undertaken before, during, or after the above elements are considered. Accordingly, the above description does not bound the scope of the claims.

The use of “capable of”, “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A computer-implemented method for detecting an unauthorized activity, the method comprising:
accessing first data that represents activity involving a first service provided to a customer;
accessing second data that represents activity involving a second service provided to a customer, wherein the activity involving the second service and the activity involving the first service both include authorized customer activity, and wherein the activity associated with the second service further includes unauthorized activity;
accessing filtering criteria for filtering the first data, wherein the filtering criteria facilitates selecting a portion of the first data for use in classifying activity associated with the second service;
filtering, on a computing device, the first data, wherein filtering is performed using the filtering criteria and includes selecting a retained portion of the first data, the retained portion of the first data being separate from a rejected portion of the first data that is not retained; and
analyzing the second data and the retained portion of the first data, wherein analyzing includes classifying the activity associated with the second service, wherein classifying distinguishes the unauthorized activity from the authorized activity associated with the second service.

2. The method of claim 1, wherein analyzing the second data and the retained portion of the first data further includes:
determining that the retained portion of the first data indicates that activity involving the first service occurred at a first location;
determining that the second data indicates that activity involving the second service occurred at a second location;
determining a distance between the first location and the second location; and
determining that the distance is greater than a distance threshold.

3. The method of claim 2, wherein analyzing the second data and the retained portion of the first data further includes:
determining an approximate amount of time between the activity at the first location and the activity at the second location, and wherein the activity at the second location is classified based on the amount of time.

4. The method of claim 1, wherein analyzing the second data and the retained portion of the first data further includes:
determining that the second data represents a first instance of abnormal activity involving the second service;
detecting an inconsistency between the first instance of abnormal activity and activity represented by the first data; and
determining, based on the detected inconsistency, that the first instance of abnormal activity is unauthorized activity.

5. The method of claim 4, wherein detecting the inconsistency includes determining that the customer is unlikely to have initiated both the abnormal activity and the activity indicated by the first data.

6. The method of claim 1, further including:
determining that the second data represents an instance of abnormal activity involving the second service;
detecting activity that is represented by the first data and is consistent with the instance of abnormal activity; and
in response to detecting the activity that is consistent, classifying the abnormal activity involving the second service as authorized activity.

7. The method of claim 1, wherein the retained portion of the first data is a subset of the first data, and wherein the filtering criteria includes a set of one or more rules associated with conditions satisfied by data in the separated portion.

8. The method of claim 7, further comprising:
determining the set of rules, wherein determining the set of rules includes:
generating multiple sets of rules; each set of rules associated with a different condition;
partitioning historical training data using the sets of rules, the historical training data including data representing activity known to be unauthorized and activity known to be unauthorized; and
analyzing partitions resulting from partitioning the historical data.

9. The method of claim 8, wherein analyzing the partitions includes:
providing each of the partitions to a model, wherein the model repeatedly generates a set of classifications of multiple instances of activity involving the second service, wherein each set of classifications is based on a different one of the partitions;
accessing known information about the multiple instances of activity; and
identifying a most accurate one of the sets of classifications, wherein identifying is based on the known information.

10. The method of claim 1, further comprising:
determining the filtering criteria based on historical information about authorized or unauthorized activity involving the second service.

11. The method of claim 10, wherein determining the filtering criteria includes defining the filtering criteria to facilitate:
identifying a portion of the first data that is inconsistent with the second data; or
identifying a portion of the first data that is consistent with the second data.

12. The method of claim 1, wherein the second data is a subset of a data superset, wherein the data superset comprises information representing activity involving the second service, and wherein accessing the second data includes:
filtering the data superset, wherein filtering the data superset is performed using second data filtering criteria, and includes determining to classify activity represented by the second data.

13. The method of claim 12, wherein the second data filtering criteria are for separating a subset of data from a data superset, wherein the subset is likely to be more informative for detecting unauthorized activity as compared to a portion of data that is in the data superset but which is not in the separated subset.

14. The method of claim 1, wherein the first data represents multiple instances of activity involving the first service, wherein the first data includes multiple first data components, and wherein each first data component represents a unique one of the multiple instances of activity involving the first service.

15. The method of claim 14, wherein filtering the first data using the filtering criteria further includes:
identifying first data components that represent:
an instance of activity associated with an amount of transacted money that is in excess of a predetermined threshold amount;
an instance of activity which is abnormal activity for the customer;
an instance of activity determined to have occurred more than a threshold distance from a residence of the customer; or
an instance of activity determined to have occurred more than a threshold distance from a location at which a previous instance of activity occurred; and
and wherein the separated portion of first data includes the identified first data components.

16. The method of claim 15, wherein filtering the first data using the filtering criteria further includes assigning a score to each of the first data components.

17. The method of claim 15, wherein filtering the first data is done without consideration of the second data.

18. The method of claim 15, wherein filtering the first data using the filtering criteria includes using a machine-learning algorithm to filter the first data, and wherein using the machine-learning algorithm includes training with historical data representing unauthorized activity involving the first service or the second service.

19. The method of claim 1, further including:
providing the first data to a detection mechanism prior to filtering the first data, wherein:
the detection mechanism is configured to detect unauthorized activity involving the first service without processing information about customer activity involving the second service.

20. The method of claim 19, wherein the filtering criteria are defined based on known detection characteristics, capabilities, or vulnerabilities of the detection mechanism.

21. The method of claim 19, wherein the detection mechanism scores components of the first data, wherein scoring includes calculating a likelihood that the scored component corresponds to unauthorized activity, and wherein filtering the first data is further based on the detection mechanism scoring.

22. A system, comprising:
one or more processors;
one or more non-transitory computer-readable storage mediums including instructions configured to cause the one or more processors to perform operations including:
accessing first data that represents activity involving a first service provided to a customer;
accessing second data that represents activity involving a second service provided to a customer, wherein the activity involving the second service and the activity involving the first service both include authorized customer activity, and wherein the activity associated with the second service further includes unauthorized activity;
accessing filtering criteria for filtering the first data, wherein the filtering criteria facilitates selecting a portion of the first data for use in classifying activity associated with the second service;
filtering, on a computing device, the first data, wherein filtering is performed using the filtering criteria and includes selecting a retained portion of the first data, the retained portion of the first data being separate from a rejected portion of the first data that is not retained; and
analyzing the second data and the retained portion of the first data, wherein analyzing includes classifying the activity associated with the second service, wherein classifying distinguishes the unauthorized activity from the authorized activity associated with the second service.

23. The system of claim 22, wherein analyzing the second data and the retained portion of the first data further includes:
determining that the retained portion of the first data indicates that activity involving the first service occurred at a first location;
determining that the second data indicates that activity involving the second service occurred at a second location;
determining a distance between the first location and the second location; and
determining that the distance is greater than a distance threshold.

24. The system of claim 23, wherein analyzing the second data and the retained portion of the first data further includes:
determining an approximate amount of time between the activity at the first location and the activity at the second location, and wherein the activity at the second location is classified based on the amount of time.

25. The system of claim 22, wherein analyzing the second data and the retained portion of the first data further includes:
determining that the second data represents a first instance of abnormal activity involving the second service;
detecting an inconsistency between the first instance of abnormal activity and activity represented by the first data; and
determining, based on the detected inconsistency, that the first instance of abnormal activity is unauthorized activity.

26. The system of claim 25, wherein detecting the inconsistency includes determining that the customer is unlikely to have initiated both the abnormal activity and the activity indicated by the first data.

27. The system of claim 22, wherein the operations further include:
determining that the second data represents an instance of abnormal activity involving the second service;
detecting activity that is represented by the first data and is consistent with the instance of abnormal activity; and
in response to detecting the activity that is consistent, classifying the abnormal activity involving the second service as authorized activity.

28. The system of claim 22, wherein the retained portion of the first data is a subset of the first data, and wherein the filtering criteria includes a set of one or more rules associated with conditions satisfied by data in the separated portion.

29. The system of claim 28, wherein the operations further include:
determining the set of rules, wherein determining the set of rules includes:
generating multiple sets of rules; each set of rules associated with a different condition;
partitioning historical training data using the sets of rules, the historical training data including data representing activity known to be unauthorized and activity known to be unauthorized; and
analyzing partitions resulting from partitioning the historical data.

30. The system of claim 29, wherein analyzing the partitions includes:
providing each of the partitions to a model, wherein the model repeatedly generates a set of classifications of multiple instances of activity involving the second service, wherein each set of classifications is based on a different one of the partitions;
accessing known information about the multiple instances of activity; and
identifying a most accurate one of the sets of classifications, wherein identifying is based on the known information.

31. The system of claim 22, wherein the operations further include:
determining the filtering criteria based on historical information about authorized or unauthorized activity involving the second service.

32. The system of claim 31, wherein determining the filtering criteria includes defining the filtering criteria to facilitate:
identifying a portion of the first data that is inconsistent with the second data; or
identifying a portion of the first data that is consistent with the second data.

33. The system of claim 22, wherein the second data is a subset of a data superset, wherein the data superset comprises information representing activity involving the second service, and wherein accessing the second data includes:
filtering the data superset, wherein filtering the data superset is performed using second data filtering criteria, and includes determining to classify activity represented by the second data.

34. The system of claim 33, wherein the second data filtering criteria are for separating a subset of data from a data superset, wherein the subset is likely to be more informative for detecting unauthorized activity as compared to a portion of data that is in the data superset but which is not in the separated subset.

35. The system of claim 22, wherein the first data represents multiple instances of activity involving the first service, wherein the first data includes multiple first data components, and wherein each first data component represents a unique one of the multiple instances of activity involving the first service.

36. The system of claim 35, wherein filtering the first data using the filtering criteria further includes:
identifying first data components that represent:
an instance of activity associated with an amount of transacted money that is in excess of a predetermined threshold amount;
an instance of activity which is abnormal activity for the customer;
an instance of activity determined to have occurred more than a threshold distance from a residence of the customer; or
an instance of activity determined to have occurred more than a threshold distance from a location at which a previous instance of activity occurred; and
and wherein the separated portion of first data includes the identified first data components.

37. The system of claim 36, wherein filtering the first data using the filtering criteria further includes assigning a score to each of the first data components.

38. The system of claim 36, wherein filtering the first data is done without consideration of the second data.

39. The system of claim 36, wherein filtering the first data using the filtering criteria includes using a machine-learning algorithm to filter the first data, and wherein using the machine-learning algorithm includes training with historical data representing unauthorized activity involving the first service or the second service.

40. The system of claim 22, wherein the operations further include:
providing the first data to a detection mechanism prior to filtering the first data, wherein:
the detection mechanism is configured to detect unauthorized activity involving the first service without processing information about customer activity involving the second service.

41. The system of claim 40, wherein the filtering criteria are defined based on known detection characteristics, capabilities, or vulnerabilities of the detection mechanism.

42. The system of claim 40 or claim 41, wherein the detection mechanism scores components of the first data, wherein scoring includes calculating a likelihood that the scored component corresponds to unauthorized activity, and wherein filtering the first data is further based on the detection mechanism scoring.

43. A computer-program product, tangibly embodied in a machine-readable non-transitory storage medium, including instructions configured to cause a data processing apparatus to perform operations including:
accessing first data that represents activity involving a first service provided to a customer;
accessing second data that represents activity involving a second service provided to a customer, wherein the activity involving the second service and the activity involving the first service both include authorized customer activity, and wherein the activity associated with the second service further includes unauthorized activity;
accessing filtering criteria for filtering the first data, wherein the filtering criteria facilitates selecting a portion of the first data for use in classifying activity associated with the second service;
filtering, on a computing device, the first data, wherein filtering is performed using the filtering criteria and includes selecting a retained portion of the first data, the retained portion of the first data being separate from a rejected portion of the first data that is not retained; and
analyzing the second data and the retained portion of the first data, wherein analyzing includes classifying the activity associated with the second service, wherein classifying distinguishes the unauthorized activity from the authorized activity associated with the second service.

44. The computer-program product of claim 43, wherein analyzing the second data and the retained portion of the first data further includes:
determining that the retained portion of the first data indicates that activity involving the first service occurred at a first location;
determining that the second data indicates that activity involving the second service occurred at a second location;
determining a distance between the first location and the second location; and
determining that the distance is greater than a distance threshold.

45. The computer-program product of claim 44, wherein analyzing the second data and the retained portion of the first data further includes:
determining an approximate amount of time between the activity at the first location and the activity at the second location, and wherein the activity at the second location is classified based on the amount of time.

46. The computer-program product of claim 43, wherein analyzing the second data and the retained portion of the first data further includes:
determining that the second data represents a first instance of abnormal activity involving the second service;
detecting an inconsistency between the first instance of abnormal activity and activity represented by the first data; and
determining, based on the detected inconsistency, that the first instance of abnormal activity is unauthorized activity.

47. The computer-program product of claim 46, wherein detecting the inconsistency includes determining that the customer is unlikely to have initiated both the abnormal activity and the activity indicated by the first data.

48. The computer-program product of claim 43, wherein the operations further include:
determining that the second data represents an instance of abnormal activity involving the second service;
detecting activity that is represented by the first data and is consistent with the instance of abnormal activity; and
in response to detecting the activity that is consistent, classifying the abnormal activity involving the second service as authorized activity.

49. The computer-program product of claim 43, wherein the retained portion of the first data is a subset of the first data, and wherein the filtering criteria includes a set of one or more rules associated with conditions satisfied by data in the separated portion.

50. The computer-program product of claim 49, wherein the operations further include:
determining the set of rules, wherein determining the set of rules includes:
generating multiple sets of rules; each set of rules associated with a different condition;
partitioning historical training data using the sets of rules, the historical training data including data representing activity known to be unauthorized and activity known to be unauthorized; and
analyzing partitions resulting from partitioning the historical data.

51. The computer-program product of claim 50, wherein analyzing the partitions includes:
providing each of the partitions to a model, wherein the model repeatedly generates a set of classifications of multiple instances of activity involving the second service, wherein each set of classifications is based on a different one of the partitions;
accessing known information about the multiple instances of activity; and
identifying a most accurate one of the sets of classifications, wherein identifying is based on the known information.

52. The computer-program product of claim 43, wherein the operations further include:
determining the filtering criteria based on historical information about authorized or unauthorized activity involving the second service.

53. The computer-program product of claim 52, wherein determining the filtering criteria includes defining the filtering criteria to facilitate:
identifying a portion of the first data that is inconsistent with the second data; or
identifying a portion of the first data that is consistent with the second data.

54. The computer-program product of claim 43, wherein the second data is a subset of a data superset, wherein the data superset comprises information representing activity involving the second service, and wherein accessing the second data includes:
filtering the data superset, wherein filtering the data superset is performed using second data filtering criteria, and includes determining to classify activity represented by the second data.

55. The computer-program product of claim 54, wherein the second data filtering criteria are for separating a subset of data from a data superset, wherein the subset is likely to be more informative for detecting unauthorized activity as compared to a portion of data that is in the data superset but which is not in the separated subset.

56. The computer-program product of claim 43, wherein the first data represents multiple instances of activity involving the first service, wherein the first data includes multiple first data components, and wherein each first data component represents a unique one of the multiple instances of activity involving the first service.

57. The computer-program product of claim 56, wherein filtering the first data using the filtering criteria further includes:
identifying first data components that represent:
an instance of activity associated with an amount of transacted money that is in excess of a predetermined threshold amount;
an instance of activity which is abnormal activity for the customer;
an instance of activity determined to have occurred more than a threshold distance from a residence of the customer; or
an instance of activity determined to have occurred more than a threshold distance from a location at which a previous instance of activity occurred; and
and wherein the separated portion of first data includes the identified first data components.

58. The computer-program product of claim 57, wherein filtering the first data using the filtering criteria further includes assigning a score to each of the first data components.

59. The computer-program product of claim 57, wherein filtering the first data is done without consideration of the second data.

60. The computer-program product of claim 57, wherein filtering the first data using the filtering criteria includes using a machine-learning algorithm to filter the first data, and wherein using the machine-learning algorithm includes training with historical data representing unauthorized activity involving the first service or the second service.

61. The computer-program product of claim 43, wherein the operations further include:
providing the first data to a detection mechanism prior to filtering the first data, wherein:
the detection mechanism is configured to detect unauthorized activity involving the first service without processing information about customer activity involving the second service.

62. The computer-program product of claim 61, wherein the filtering criteria are defined based on known detection characteristics, capabilities, or vulnerabilities of the detection mechanism.

63. The computer-program product of claim 61 or claim 62, wherein the detection mechanism scores components of the first data, wherein scoring includes calculating a likelihood that the scored component corresponds to unauthorized activity, and wherein filtering the first data is further based on the detection mechanism scoring.
